(19) United States
(12) Patent Application Publication
(10) Pub. No.: US 2023/0263356 A1
(43) Pub. Date: Aug. 24, 2023

(54) CONTROL OF A CLEANING ROBOT

(71) Applicant: BSH Hausgeräte GmbH, München (DE)

(72) Inventors: Markus Kühnel, Radeberg (DE); Frank Schnitzer, Bad Neustadt (DE)

(21) Appl. No.: 18/005,217

(22) PCT Filed: Jul. 6, 2021
(86) PCT No.: PCT/EP2021/068631

§ 371 Date: Jan. 12, 2023

(30) Foreign Application Priority Data
Jul. 16, 2020 (DE) 10 2020 208 893.4

(51) Int. Cl. A47L 11/40; A47L 11/28; A47L 11/24; A47L 9/28; G05D 1/00; G05D 1/02

(52) U.S. Cl. CPC A47L 11/4011; A47L 11/28; A47L 11/24; A47L 9/2805; A47L 9/2852; A47L 9/2894; G05D 1/0044; G05D 1/0223; G05D 1/0214; A47L 2201/06; A47L 2201/04; G05D 2201/0203

(57) ABSTRACT

A cleaning robot is configured to clean a predetermined floor area. A method for controlling the cleaning robot includes determining a section of the floor area, the treatment of which by the cleaning robot is intended to differ from that of the remaining floor area, deactivating a cleaning facility of the cleaning robot, controlling the cleaning robot to travel along a boundary of the section, detecting a user-controlled confirmation of the boundary traveled along, and enabling the cleaning facility. A control apparatus and a system including a cleaning robot are also provided.

The invention relates to a cleaning robot. In particular, the invention relates to the control of the cleaning robot in relation to a section of a floor area which is not to be cleaned.

A cleaning robot is configured to clean a predetermined floor area. To this end, the cleaning robot is able to investigate the floor area itself and provide a map, which comprises obstacles or boundaries detected on the floor area. It may not be possible, however, for the cleaning robot to detect certain features in its environment. If an additional carpet were to be lying on a carpeted floor, for example, then the cleaning robot may possibly be unable to distinguish between ii the two surfaces.

For example, the publication WO 2018/158 248 A2 describes a cleaning robot for cleaning a predetermined floor area, in which boundaries may apply, along which the cleaning robot can be controlled.

Occasionally, it is desired to not have a predetermined section of the floor area cleaned by the cleaning robot. In the example mentioned, the carpeted floor may be cleaned for instance, while the additional carpet is not to be cleaned, for example because it comprises a particularly long pile, in which the cleaning robot may become tangled. A user is able to indicate a section that the cleaning robot is not to clean on the map provided by the cleaning robot. The input usually takes place by the user viewing the map on a screen of a mobile device and defining the section, for example in the form of a rectangle, a circle or a polygon.

In this context, it may be difficult for the user to define the section in a sufficiently exact manner, because the obstacle to be avoided, in the example above the long-pile carpet, cannot be entered on the map. Additionally, a screen of a mobile device is usually very small, meaning that precise input is made difficult. As a result, the section not to be cleaned may be defined too small, meaning that the cleaning robot travels on it; or too large, meaning that an uncleaned border may remain around it; or with the wrong position, meaning that both of these problems mentioned may occur.

One object underlying the present invention consists in disclosing an improved technique for defining a section of a floor area, which is not to be cleaned, for a floor cleaning robot. The invention achieves this object by means of the subject matter of the independent claims. Subclaims indicate preferred embodiments.

A cleaning robot is configured to clean a predetermined floor area. According to a first aspect of the present invention, a method for controlling the cleaning robot comprises steps of determining a section of the floor area, the processing of which by the cleaning robot is to be different from the remaining floor area; deactivating a cleaning facility of the cleaning robot; controlling the cleaning robot to travel along a boundary of the section; detecting a user-controlled confirmation that the boundary has been traveled along; and enabling the cleaning facility.

In one embodiment, a specific cleaning method is to be applied on the section. In particular, a protective cleaning may be controlled on the section, for example in a dry manner, without the use of a brush or a broom, with reduced frequency or in a slower manner. It can therefore be prevented, for example, that a carpet is wet-cleaned or that a rotation element of the cleaning robot becomes entangled in fringes or tassels of a carpet. In another embodiment, a cleaning of the section can be fully omitted, meaning that the section is excluded from being processed by the cleaning robot. The following is primarily based on this embodiment as a representation.

According to the invention, the cleaning robot is able to practically demonstrate exactly where the boundary of the section of the floor area, which is not to be cleaned, runs. If he agrees with the boundary shown, a user is able to allow the cleaning robot to operate on a remaining floor area through his confirmation. The cleaning robot can be actuated to automatically clean the remaining floor area. Otherwise, if the user is not satisfied, he is able to redefine the section or modify an existing definition and optionally request that the cleaning robot traverses the boundary of the section again. The user is also able to discard the definition that has been input. According to the invention, the section can be defined more quickly and with greater precision in this manner. While the boundary is being traversed, the user can immediately decide whether this has been chosen effectively or needs amending.

It is preferred that the section is determined in relation to a map which maps the predetermined section. For example, the section can be defined on the map as a rectangle, ellipse or polygon. A section or region not to be cleaned or not to be traveled can also be referred to as a no-go region. Multiple no-go regions can be merged automatically, if they overlap with one another or lie close enough to one another that the cleaning robot is not able to pass between them. In a similar manner, a no-go region may be combined with another region, which represents an obstacle on the floor area. A no-go region may also be combined with a boundary of the floor area.

It is particularly preferred that the map is determined on the basis of scans of the floor area that have been carried out by the cleaning robot. In usual operation, the cleaning robot is guided by map data which it has produced itself or augmented with information it has scanned itself. By using this map for determining the section of the floor area which is not to be cleaned, an error in the input can be minimized. The determination of the section can be known in a more representative or realistic manner than before.

In a further embodiment, the cleaning robot is controlled to travel along the boundary at reduced speed. Expressed differently, a speed at which the cleaning robot travels along the boundary can be predetermined, wherein the predetermined speed may be lower than a marching speed at which the cleaning robot usually moves from one place to another, or lower than travel speed at which it moves during a cleaning procedure. As a result, a user can be given more time to control the exact course of the boundary of the section while it is being traversed, or to interrupt the travel prematurely if there is an impending collision or overlap with an object to be omitted.

In another embodiment, a speed of the cleaning robot can be controlled by a user while it is traveling along the boundary. The speed can preferably be altered during the travel, meaning that the user is able to choose a low speed, for example, if he wishes to observe the process exactly, and a higher speed if he is already satisfied with the boundary or does not anticipate any problems.

In one variant, the cleaning robot is controlled along the boundary in such a manner that it does not touch the determined section. In this context, the distance between the cleaning robot and the section should be minimized as far as possible. Thus, it can be ensured that the section is in no way affected by the cleaning robot. In a second variant, the cleaning robot is controlled along the boundary in such a manner that only the cleaning facility does not touch the determined section. Traveling on the section may be allowed here. In particular, a section of the cleaning facility which lies in the immediate vicinity of the floor area is not able to touch the determined section here. It is also preferred here that the distance between the cleaning facility and the section is minimized. As a result, it is possible to reduce a region between an object lying on the floor area which is not to be cleaned and a region which is to be cleaned, in an improved manner. If the cleaning facility is narrower than the cleaning robot, for example, then the cleaning robot is able to travel on the predetermined section of the floor area, as long as the cleaning facility does not intrude into the section.

In yet another embodiment, the section is determined by the cleaning robot being controlled along a boundary of the section on the basis of user-controlled inputs. The control can take place in particular in the manner of a remote control, which for example may allow the direction and/or speed of the cleaning robot to be altered. A procedure of this kind may also be referred to as a “teach-in”.

In yet another embodiment, a user-controlled changing of the section is determined, wherein the cleaning robot is controlled to travel along a changed section of the boundary of the section. In particular, the cleaning robot can be controlled to only travel along the changed section of the boundary. Fine-tuning when determining a section of the floor area which is not to be cleaned can be supported as a result. A test of whether the determined section corresponds to what the user imagined can take place considerably more quickly by selectively traversing only the altered section of its boundary.

In a further embodiment, while traveling along the boundary, the cleaning robot is controlled to give an indication of which side of the traveled boundary is included in the section. As a result, it is possible to avoid an accidental inversion, in which a section of the floor area which is to be cleaned and a section of the floor area which is not to be cleaned are confused with one another. This may happen, for example, if a section of the floor area which is not to be cleaned is complex, for instance because it has been merged with one or more further sections, obstacles or boundaries. The indication can also contribute to avoiding an incorrect definition if the section is determined on the basis of a decision which cannot be perceived on the floor area, for example if only an eastern part of a room is to be cleaned.

It is generally preferred that the cleaning robot is only moved along a boundary which lies between the region not to be cleaned and a region to be cleaned. Expressed differently, it is only possible to traverse the part of the boundary that can be accessed at least on one side and does not extend along a wall or an obstacle, for example.

According to a second aspect of the present invention, a control apparatus for a cleaning robot, which is configured to process a predetermined floor area, comprises a determining facility for determining a section of the floor area which is not to be cleaned; a processing facility, which is configured to deactivate a cleaning facility of the cleaning robot and to control the cleaning robot to travel along a boundary of the section; and an input apparatus for a user-controlled confirmation that the boundary has been traveled along. In this context, the processing facility is preferably further configured to enable the cleaning facility in response to a detected user-controlled confirmation that the boundary has been traveled along.

The processing facility may be configured to fully or partially carry out a method described herein. To this end, the processing facility may comprise a programmable microcomputer or microcontroller and the method may be present in the form of a computer program product with program code means. The computer program product may also be saved on a computer-readable data carrier. Features or advantages of the method can be transferred to the apparatus, or vice versa.

According to a third aspect of the present invention, a cleaning robot comprises a control apparatus described herein. The cleaning robot may comprise a cleaning facility, which in a particularly preferred embodiment comprises a suction facility, a mopping facility and/or a sweeping facility. Expressed differently, the cleaning robot may comprise a vacuum cleaner robot or a sweeper robot. The mopping facility may be configured for moistening the floor area. A combined embodiment, which is configured for vacuum cleaning and sweeping for example, is also conceivable. The cleaning robot is preferably provided for use in a household. In a further embodiment, the cleaning robot may also be used, for example, for cleaning an industrial area or a floor area of an office.

According to yet another aspect of the present invention, a system comprises a cleaning robot described herein and a mobile operating unit with an output apparatus for outputting an environment map of the cleaning robot and an input apparatus for inputting a section of the floor area that is not to be cleaned, and also for inputting a user-controlled confirmation. The operating unit is preferably connected to the control apparatus in a wireless manner. In particular, the operating unit may be formed by a mobile device, such as a smartphone, a tablet computer or a laptop computer, on which a corresponding computer program is installed.

The invention is now explained in more detail with reference to the accompanying drawings, in which:

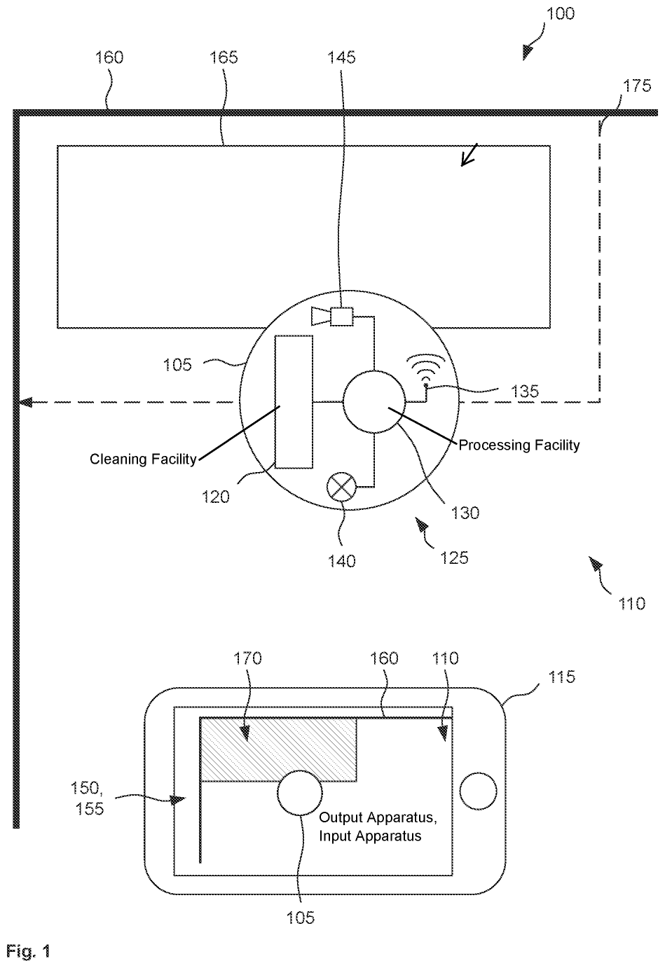

FIG. 1 shows a system with a cleaning robot;

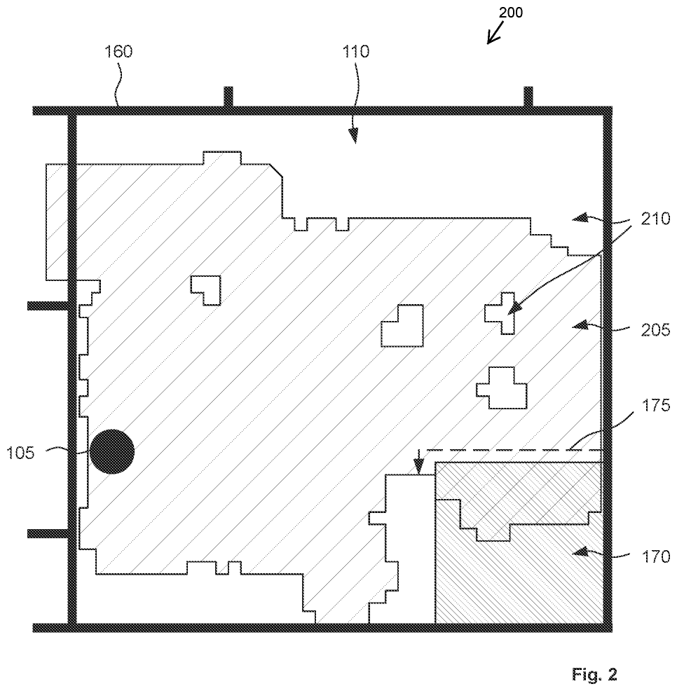

FIG. 2 shows an exemplary map of a floor area; and

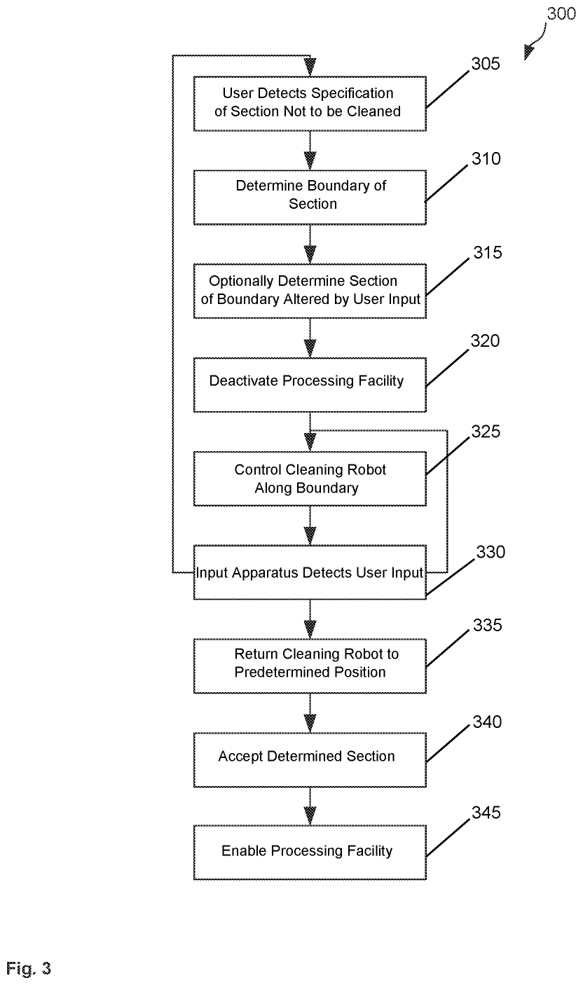

FIG. 3 shows a flow diagram of a method.

FIG. 1 shows a system 100 with a cleaning robot 105, which is configured for cleaning a floor area 110, and an optional mobile operating unit 115, which in the present case is embodied by way of example as a smartphone.

The cleaning robot 105 is configured to travel over the floor area 110 and clean a section of the floor area 110 lying in its range by means of a cleaning facility 120. The cleaning facility 120 comprises, for example, a suction mechanism, a mopping facility, in particular with a moisture facility, and/or a sweeping facility, for example with a rotating brush roller, or a combination of the two facilities. The cleaning facility 120 is usually designed to be narrower than the cleaning robot 105. Control of the cleaning robot 105 preferably takes place by means of a control apparatus 125.

The control apparatus 125 preferably comprises a processing facility 130 and an optional communication facility 135, which is configured to communicate with the operating unit 115. In another embodiment, elements of the operating unit 115 are included in the cleaning robot 105 and it is possible to dispense with the communication facility 135. The processing facility 130 is preferably further configured to control an operation of the cleaning facility 120. Additionally, one or more indicators 140 may be provided, in order for example to indicate a right-hand or left-hand region of the floor area 110 in relation to a direction of travel of the cleaning robot 105. An indicator 140 may be designed as visual, for example, and comprise a light or an LED.

In a further preferable manner, the processing facility 130 is connected to a sensor 145, which is configured to scan an environment of the cleaning robot 105. On the basis of scans of the sensor 145, a map of the environment can be created. The map may be stored in a data storage unit, which may be included in the processing facility 130.

The operating unit 115 preferably comprises an output apparatus 150 and an input apparatus 155, which in the present case are designed as combined with one another in the form of a touchscreen. The output apparatus 150 is configured to visually represent the map mentioned. The input apparatus 155 is configured to detect various inputs of a user, in particular in relation to the map and/or a control of the cleaning robot 105.

The floor area 110 may be delimited on one or more sides by a wall 160. For example, due to an object 165 on the floor area 110, it may be desired to not have a section 170 of the floor area 110 covering the object 165 cleaned by the cleaning robot 105. A user can define the section 170 in relation to the map shown by means of the input apparatus 155. In this context, the object 165 may not be included in the map and the defined section 170 usually cannot be seen in reality. It is proposed to determine a boundary 175, which exists between the section 170 and a remaining part of the floor area 110 to be processed by the cleaning robot 105. The cleaning robot 105 can then be actuated to travel along the boundary 175 while the cleaning facility 120 is deactivated. In this context, a user can be satisfied that the section 170 has been chosen correctly. He can confirm the section 170 or the traversed boundary 175 by means of the input apparatus 155, meaning that the control apparatus 125 omits the defined section 170 on a following processing procedure of the floor area 110.

FIG. 2 shows an exemplary map 200 of a floor area 110. The map 200 represents a top view of a section of a building, in particular a residential building. The cleaning robot 105 has traveled the region shown and scanned it by means of its sensors 145. As a result, it has determined a travelable region 205, which is delimited by walls 160. Non-travelable regions 210 result from obstacles, for example furniture.

A section 170 is not to be traveled at the request of a user. Parts of this section 170 are already included in the non-travelable region 210. By defining the section 170, a boundary 175 is specified, which extends in the region in which the section 170 diminishes on the travelable region 205.

FIG. 3 shows a flow diagram of a method 300 for controlling a cleaning robot 105. It is assumed that, before starting the method 300 shown, a sufficiently exact map or environment map 200 of a floor area 110, which can be cleaned by the cleaning robot 105, is already available. This map 200 in particular may have been collected by scans by the cleaning robot 105 while traveling on the floor area 110 in a systematic or erratic manner.

In a step 305, a specification of a section 170 can be detected by a user. In a step 310, the boundary 175 of the section 170 can be determined. Preferably, only a section of the boundary 175 that can be traveled by the cleaning robot 105 on at least one side is determined. A part of the boundary 175 that lies too close to a wall 160, a non-travelable region 210 or a known obstacle can be disregarded. Optionally, the boundary 175 can be determined once the specified section 170 has been merged with a further, previously specified section 170. It is also possible for a non-travelable region 210 or a boundary of the floor area 110, for example in the form of a wall 160, to be taken into consideration when determining the boundary 175.

In an optional step 315, it is possible to determine a section of the boundary 175 which has been altered by the present input of the user compared to a previous version. In this case, the boundary 175 may temporarily be reduced to the altered region.

In a step 320, the processing facility 120 may be deactivated. Subsequently, the cleaning robot 105 can be controlled along the boundary 175 in a step 325. In this context, by means of the indicator 140, it is possible to give an indication on the side of the boundary 175 which is not to be processed in usual operation. Conversely, it is also possible to indicate the side of the boundary 175 which is to be processed. In order to traverse the boundary 175, the cleaning robot 105 may first be moved to a first end of the boundary 175, from which it follows the boundary 175. While traversing the boundary 175, it is preferred to choose a travel speed such that it is made easier for the user to assess the location and size of the section 170 on the real floor area 110. In one embodiment, the user himself is able to control the speed of the cleaning robot 105. In another embodiment, the speed can be specified at a predetermined value. This value preferably corresponds to a slow movement.

In a step 330, an input of a user by means of the input apparatus 155 can be detected. For example, the input may be detected while traversing the boundary 175 and cause an interruption or stopping of the cleaning robot 105. If the user is not satisfied with the specified section 170 due to the previous traversal of the boundary 175, for example then he can alter the section 170, wherein the method 300 may return to step 305. In a further embodiment, the input may comprise a correction of the boundary 175, while the cleaning robot 105 travels on the boundary 175. If the cleaning robot 105 has traversed the entire boundary 175 or the previously determined section of the boundary 175, then it is possible to detect a confirmation of the user that he agrees with the traversed boundary 175 or the section 170 corresponding thereto. Optionally, the user may also wish for the boundary 175 to be traversed again. In yet another embodiment, an agreement by the user may be assumed, if an input cannot be detected within a predetermined time.

In a step 335, the cleaning robot 105 can be actuated to return to a predetermined position. In particular, this position may lie at a base station, at which the cleaning robot 105 can be supplied with electrical energy or relieved of collected dirt particles, for example.

In a step 340, if this has not already taken place, the determined section 170 can be accepted. This means that the determined section 170 is omitted during a following cleaning movement over the floor area 110. Optionally, the determined section 170 can also be discarded, if it was not explicitly confirmed by a user before the cleaning robot 105 has returned to the predetermined position.

In a step 345, the processing facility 120 can be enabled again. In the following, it is possible to control a cleaning of the floor area 110 by means of the cleaning robot 105.

It should be noted that the steps of the method 300 shown are not all mandatory and do not necessarily have to take place in the order shown. In particular, the steps 335 to 345 can also be dispensed with on an individual basis or can be performed in a different order.

### REFERENCE CHARACTERS

100 System
105 Cleaning robot
110 Floor area
115 Operating unit
120 Cleaning facility
125 Control apparatus
130 Processing facility
135 Communication facility
140 Indicator
145 Sensor
150 Output apparatus
155 Input apparatus
160 Wall
165 Object
170 Section
175 Boundary
200 Map
205 Travelable region
210 Non-travelable region
300 Method
305 Specify no-go section
310 Determine boundary
315 Determine altered section of the boundary
320 Deactivate processing facility
325 Control cleaning robot along boundary
330 Detect input
335 Return to base station
340 Accept no-go section
345 Enable processing facility

1-15. (canceled)

16. A method for controlling a cleaning robot configured to clean a predetermined floor area, the method comprising:
determining a section of the floor area to be processed by the cleaning robot differently than a remaining floor area;
deactivating a cleaning facility of the cleaning robot;
controlling the cleaning robot to travel along a boundary of the section;
detecting a user-controlled confirmation of the boundary traveled along; and
enabling the cleaning facility.

17. The method according to claim 16, which further comprises determining the section in relation to a map mapping the predetermined floor area.

18. The method according to claim 17, which further comprises determining the map based on scans of the floor area carried out by the cleaning robot.

19. The method according to claim 16, which further comprises reducing a speed at which the cleaning robot travels along the boundary.

20. The method according to claim 16, which further comprises controlling a speed of the cleaning robot by a user while the cleaning robot is traveling along the boundary.

21. The method according to claim 16, which further comprises controlling the travel of the cleaning robot along the boundary by preventing the cleaning robot from touching the determined section.

22. The method according to claim 16, which further comprises controlling the travel of the cleaning robot along the boundary by preventing the cleaning facility from touching the determined section.

23. The method according to claim 16, which further comprises determining the section by controlling the travel of the cleaning robot along the boundary of the section based on user-controlled inputs.

24. The method according to claim 16, which further comprises determining a user-controlled changing of the section, and controlling the cleaning robot to travel along a changed section of the boundary of the section.

25. The method according to claim 16, which further comprises, while traveling along the boundary, controlling the cleaning robot to give an indication of a side of the traveled boundary included in the section.

26. The method according to claim 16, which further comprises locating the boundary between a region not to be cleaned and a region to be cleaned.

27. A control apparatus for a cleaning robot configured to process a predetermined floor area, the control apparatus comprising:
a determining facility for determining a section of the floor area to be processed by the cleaning robot differently than a remaining floor area;
a processing facility configured to deactivate a cleaning facility of the cleaning robot and to control the cleaning robot to travel along a boundary of the section; and
an input apparatus for inputting a user-controlled confirmation of the boundary being traveled along;
said processing facility configured to enable said cleaning facility in response to a detected user-controlled confirmation that the boundary has been traveled along.

28. A cleaning robot, comprising a control apparatus according to claim 27.

29. The cleaning robot according to claim 28, which further comprises a cleaning facility including at least one of a suction facility, a mopping facility or a sweeping facility.

30. A system, comprising:
a cleaning robot according to claim 28; and
a mobile operating unit;
said mobile operating unit including an output apparatus for outputting an environment map of the cleaning robot; and
said mobile operating unit including an input apparatus for inputting a section of the floor area not to be cleaned, and for inputting a user-controlled confirmation.
